(19) United States
(12) Patent Application Publication
(10) Pub. No.: US 2008/0089999 A1
(43) Pub. Date: Apr. 17, 2008

(54) Method for producing a nutritional supplement using fish roe

(76) Inventor: David Alpern, Los Angeles, CA (US)

Correspondence Address: ZUBER & TAILLIEU, LLP, 9TH FLOOR, 9595 WILSHIRE BLVD., BEVERLY HILLS, CA, 90212, US

(21) Appl. No.: 11/581,895

(22) Filed: Oct. 17, 2006

(51) Int. Cl. A23L 1/325

(52) U.S. Cl. 426/643

(57) ABSTRACT

The present invention relates to a nutritional supplement derived from fish roe.

### BACKGROUND OF INVENTION

The present invention relates to a novel method for producing a nutritional supplement that provides vitamin A, vitamin D, vitamin B-12, Omega-3 fatty acids, and minerals. While sufficient levels of vitamins A, D, and B-12 have long been held as critical in maintaining good health, Omega-3 fatty acids have gained more recent popularity due to the numerous studies and research findings suggesting that Omega-3 fatty acids play a role in cardiovascular health and disease prevention. This benefit holds particular importance in the United States because heart disease is the leading cause of death in America, according to the American Heart Association.

Vitamin A is an antioxidant vitamin that is important in vision and bone growth. Deficiencies in vitamin A may lead to night blindness and lessen a body's ability to fight off infections.

Vitamin D is associated with maintaining a strong skeletal system. Deficiencies in vitamin D may lead to rickets, osteoporosis, and osteomalacia, a bone-thinning disorder.

Vitamin B-12 is associated with the formation of red blood cells and maintaining a healthy nervous system. Vitamin B-12 deficiencies are related to anemia and neurological disorders.

Omega-3 fatty acids are polyunsaturated fatty acids and cannot be synthesized by the body. Accordingly, Omega-3 fatty acids must be obtained from outside sources. Docosahexanoic acid (“DHA”) and eicosapentaenoic acid (“EPA”) are two important omega-3 fatty acids that benefit human health and are found in fish and fish products. Epidemiological studies of populations consuming large amounts of fish rich in omega-3 fatty acids have found said populations to suffer fewer cardiovascular events. Benefits of regular consumption of omega-3 fatty acids include decreased incidence of cardiovascular disease, improved HDL:LDL cholesterol ratios, and a reduction in serum triglyceride levels (U.S. Pat. No. 5,897,890).

In view of the important roles the above vitamins and nutrients play in regulating human health, it is evident that maintaining optimal levels of said vitamins and physiologically active agents is critical. Prior art methods of obtaining said nutrients have had numerous shortcomings related to obtaining safe and appropriate dosages for human health and providing key vitamins and minerals. Fish body oil in the form of capsules or liquid is a commonly consumed source of Omega-3 fatty acids. Fish body oil does not provide vitamins A and D. Cod liver oil is another popular source of Omega-3 fatty acids. Cod liver oil however, contains high levels of vitamins A and D and may expose users to toxic levels if consumed regularly. Toxic levels of vitamins A and D seriously injure human health and are associated heart disease, osteoporosis, rashes, and even death.

The present invention teaches a novel method of producing a nutritional supplement that utilizes the contents of fish roe from female fish, or “hard roe” as a source of vital minerals and nutrients. Extracting and concentrating the contents of fish roe produce a dietary supplement that provides safe and beneficial levels of vitamins A, D, B, and Omega-3 fatty acids. In addition, the present invention provides a natural source of vitamins and minerals that does not rely on costly laboratory procedures and equipment.

It is an object of the present invention to provide a nutritional supplement that provides healthful quantities of vitamins A, B, and D.

It is a further object of the present invention to provide a nutritional supplement that provides healthful quantities of Omega-3 fatty acids for cardiovascular benefits.

It is an additional object of the present invention to provide a nutritional supplement that derives vitamins A, B, D, and Omega-3 fatty acids from a natural source.

### SUMMARY OF INVENTION

The present invention teaches a novel method for producing a nutritional supplement from fish roe.

### DESCRIPTION OF PREFERRED EMBODIMENT

Numerous female species of fish may be utilized for the practice of the present invention. Suitable species include, but are not limited to salmon, cod, Pollock, haddock, herring, paddlefish, sturgeon, lumpfish, whitefish, mullet, smelt, sardine, tuna, capelin, mullet and flying fish. In the preferred embodiment of the present invention, roe from wild caught female salmon is especially desirable because this type of fish is rich in Omega-3 fatty acids. Wild salmon may also have lower levels of environmental pollutants when compared to fish that are farm raised.

Fish roe is a widely consumed delicacy. Numerous devices and equipment have been designed for purposes of roe removal. Roe exposure and removal may be accomplished manually or through the use of automated equipment using methods known in the art.

Once exposed, the roe may be easily isolated and collected from the fish. The roe is further processed by means including pressing and vacuum distillation, separation techniques both known in the art. Pressing of the roe may be effectively accomplished using a planar object and a sieve. Pressure exerted upon the roe by the planar object allows for the extraction of the liquid component from the roe. Openings provided within the sieve should be sufficient to prevent passage of the solid component, namely the membrane portion, of the roe.

After pressing the roe and separating the liquid component from the solid component, the solid component may be discarded. The solid component comprises primarily of roe membrane which are made up of myogenic fiber proteins. The liquid component comprises of water, Omega-3 fatty acids, protein, vitamins, and minerals.

Excess water from the liquid component of the roe may be removed by vacuum distillation whereby the pressure above the solution is maintained at less than 1 atmosphere. The components of the solution will be separated out by boiling point, with the component having the lowest boiling point being separated first. The solution may be heated to further facilitate the distillation process. The solution is distilled until the constituents of interest are separated out. Said constituents include Omega-3 fatty acids, protein, vitamins including vitamins A, D, B, and minerals. Other separation techniques known in the art may be performed to achieve the same result and this application is not intended to be limited in scope by the separation techniques described above.

When the Omega-3 fatty acids, vitamins A, D, and B are separated out, they are combined and an ingestible form of vitamin E may be added in a quantity sufficient to prevent spoliation. The composition may be ingested as a liquid when combined with a consumable liquid or encapsulated into gelatin capsules by methods known in the art. The composition may also be combined with fish body oil or cod liver oil and consumed as a liquid or encapsulated in gelatin capsules.

The composition of the vitamins and nutrients provided for in roe will vary depending on the species of the fish. Data on Alaskan Salmon Roe is provided for below:

Alaskan Salmon Roe
Composition per 100 grams

| | | |
|---|---|---|
| DHA | 2.17 | g |
| EPA | 1.90 | g |
| calcium | 100 | mg |
| Vitamin A | 500 | iu |
| Vitamin D | 47 | ug |
| Vitamin B1 | .50 | mg |
| Vitamin B2 | .40 | mg |
| Vitamin B12 | 47.3 | ug |
| lecithin | 150 | ug |

As discussed above, roe from Alaskan Salmon is used to practice a preferred embodiment of the invention due to the high levels of Omega-3 fatty acids found in said fish. Other suitable species of fish may be used and derive the same benefits as those from Alaskan Salmon including cod, Pollock, haddock, herring, paddlefish, sturgeon, lumpfish, whitefish, mullet, smelt, sardine, tuna, capelin, mullet and flying fish. In summary, the present invention is a novel method for producing a nutritional supplement that obtains vitamins and nutrients from a natural source.

With respect to the above description, it is to be realized that variations such as species of fish, separation methods, equipment, supplements, etc. may be employed and still fall within the scope of protection granted by this description. Therefore, the foregoing is considered as illustrative only of the principles of the invention and shall not serve to limit or restritct the scope of this application.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. A method of producing a nutritional supplement from fish roe, said method comprising:
separating a liquid component of the roe from a solid component of the roe;
extracting at least one nutritional substance from said liquid component of the roe;
forming a nutritional supplement from said at least one nutritional substance.

17. The method of claim 16 wherein the at least one nutritional substance which is extracted from the liquid component is selected from one of the following: Omega 3 fatty acids, protein, vitamin A, vitamin B, vitamin D, or minerals.

18. The method of claim 16, wherein the extraction of at least one nutritional substance from the liquid component of the roe is accomplished through vacuum distillation.

19. The method of claim 16 wherein consumable vitamin E is added to the at least one nutritional substance when forming the nutritional supplement.

20. The method of claim 16, wherein the at least one nutritional substance is combined with a consumable liquid when forming the nutritional supplement.

21. The method of claim 16, wherein fish body oil is combined with the at least one nutritional substance when forming the nutritional supplement.

22. The method of claim 16, wherein cod liver oil is combined with the at least one nutritional substance when forming the nutritional supplement.

23. The method of claim 16, wherein the at least one nutritional substance is encapsulated into gelatin capsules when forming the nutritional supplement.

24. The method of claim 16, wherein the fish roe is obtained from salmon.

25. The method of claim 16, wherein the fish roe is obtained from cod.

26. The method of claim 16, wherein the fish roe is obtained from pollock.

27. A method of producing a nutritional supplement from fish roe, said method comprising:
separating a liquid component of the roe from a solid component of the roe;
forming a nutritional supplement from said liquid component of the roe.

28. The method of claim 27, wherein the step of forming a nutritional supplement from the liquid component includes removing at least one nutritional substance from the liquid component of the roe.

29. The method of claim 28, wherein the at least one nutritional substance which is removed from the liquid component is selected from one of the following: Omega 3 fatty acids, protein, vitamin A, vitamin B, vitamin D, or minerals.

30. The method of claim 28, wherein removal of the at least one nutritional substance from the liquid component of the roe is accomplished through vacuum distillation.

31. The method of claim 28, wherein consumable vitamin E is added to the at least one nutritional substance when forming the nutritional supplement.

32. The method of claim 28, wherein the at least one nutritional substance is combined with a consumable liquid when forming the nutritional supplement.

33. The method of claim 28, wherein fish body oil is combined with the at least one nutritional substance when forming the nutritional supplement.

34. The method of claim 28, wherein cod liver oil is combined with the at least one nutritional substance when forming the nutritional supplement.

35. The method of claim 28, wherein the at least one nutritional substance of the roe is encapsulated into gelatin capsules when forming the nutritional supplement.

36. The method of claim 28, wherein the fish roe is obtained from salmon.

37. The method of claim 28, wherein the fish roe is obtained from cod.

38. The method of claim 28, wherein the fish roe is obtained from pollock.
